(19) United States
(12) Patent Application Publication
(10) Pub. No.: US 2020/0045000 A1
(43) Pub. Date: Feb. 6, 2020

(54) NOTIFICATION SYSTEM CAPABLE OF ATTACHING PICTURES

(71) Applicant: AVIVID INNOVATIVE MEDIA CO., LTD, Taipei City (TW)

(72) Inventor: CHIH-YAO LIN, Taipei City (TW)

(73) Assignee: AVIVID INNOVATIVE MEDIA CO., LTD, Taipei City (TW)

(21) Appl. No.: 16/528,821

(22) Filed: Aug. 1, 2019

(30) Foreign Application Priority Data
Aug. 1, 2018 (TW) 107210537

(51) Int. Cl. H04L 12/58; G06F 16/955; G06Q 30/02

(52) U.S. Cl. CPC H04L 51/046; G06F 16/9566; H04L 51/24; G06Q 30/0267; H04L 51/10; G06Q 30/0277

(57) ABSTRACT

A notification system capable of attaching pictures includes an editing device, a server, and multiple receiving devices. The editing device includes a data input module for inputting notification editing information. The notification editing information includes at least a picture datum and at least a URL link datum. The server is communicatively connected to the editing device for receiving the notification editing information. The server includes an insert module provided for receiving the notification editing information and inserting the notification editing information into notification information. The receiving device is communicatively connected to the server and includes a receiving module and a display module. The receiving module is provided for receiving the notification information, and the display module is provided for displaying the notification information.

### BACKGROUND OF INVENTION

### Field of Invention

The present invention relates to a notification system, in particular to the notification system capable of inserting pictures into a notification message and connecting to a network.

### Description of the Related Art

Notification is a common information transmission method in present network applications, wherein notices are usually sent to users through an APP. Now, a webpage browser can be used to send notification messages, and the notification messages can be used as an advertising medium.

However, most conventional messages can carry texts, icons attached with the information source, or APPs only, but cannot carry too much information. Therefore, the information carried by the message is still limited, and the advertising effect is low. On the other hand, the notification message is one of the fast methods used for transmitting messages and contacting consumers.

In summation of the description above, it is an important subject for the related industry to let the notification message carry more information and maximize the advertising effect.

### SUMMARY OF THE INVENTION

Therefore, it is a primary objective of the present invention to provide a notification system capable of attaching pictures and increasing the quantity of information carried by the notification message by inserting pictures into the notification message through other software or systems and connecting to a URL website, so as to provide a better advertising effect.

To achieve the aforementioned and other objectives, the present invention provides a notification system capable of attaching pictures comprising an editing device, a server and a plurality of receiving devices. The editing device includes a data input module for inputting notification editing information, and the notification editing information includes at least a picture datum and at least a URL link datum. The server is communicatively coupled to the editing device for receiving the notification editing information, and the server includes an insert module for receiving the notification editing information and inserting the notification editing information into notification information. The receiving device is communicatively coupled to the server, and the receiving device includes a receiving module and a display module. The receiving module is provided receiving the notification information. The display module is provided for displaying the notification information.

In the notification system capable of attaching pictures in accordance with the present invention, the notification editing information includes a picture datum and two URL link data.

In the notification system capable of attaching pictures in accordance with the present invention, the receiving device is a tablet PC, a smartphone, or a personal computer.

In the notification system capable of attaching pictures in accordance with the present invention, the notification editing information and the notification information have contents which are not associated with each other.

In the notification system capable of attaching pictures in accordance with the present invention, the URL link information in the notification information is expressed in form of a text button.

In the notification system capable of attaching pictures in accordance with the present invention, the notification information comes from an external notification transmission device, and the notification transmission device is coupled to the server.

In the notification system capable of attaching pictures in accordance with the present invention, the notification editing information includes a text message and a title message.

### BRIEF DESCRIPTION OF THE FIGURES

FIG. 1 is a schematic block diagram showing a notification system capable of attaching pictures in accordance with the present invention;

FIG. 2 is a schematic view of displaying notification information in accordance with first embodiment of the present invention;

FIG. 3A is a schematic view of notification advertising in accordance with second embodiment of the present invention;

FIG. 3B is a schematic view of notification advertising in accordance with third embodiment of the present invention

FIG. 4 is a schematic view of notification advertising in accordance with a fourth embodiment of the present invention; and

FIG. 5 is a schematic view of notification advertising in accordance with fifth embodiment of the present invention

### DESCRIPTION OF THE INVENTION

To make it easier for our examiner to understand the objective, technical characteristics, structure, innovative features, and performance of the invention, we use preferred embodiments together with the attached figures for the detailed description of the invention. It is intended that the embodiments and figures disclosed herein are to be considered illustrative rather than restrictive.

In the notification system capable of attaching pictures in accordance with the present invention, pictures and URL links are inserted into the notification message come from an APP or a webpage, so that the notification message can carry more information to create more advertising exposure opportunities.

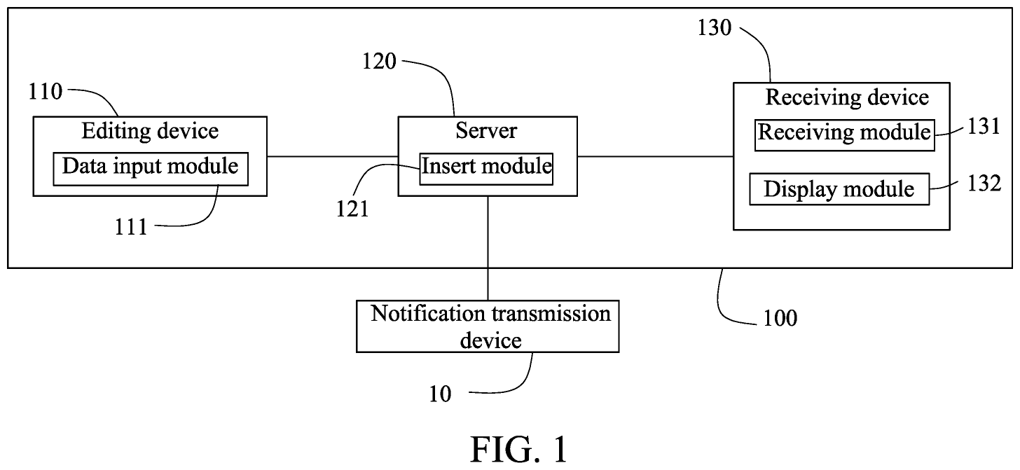

With reference to FIG. 1 for a notification system capable of attaching pictures in accordance with the present invention, the notification system capable of attaching pictures 100 comprises an editing device 110, a server 120, and a receiving device 130. For example, the editing device 110 may be a computer device used by an advertiser who wants to place an advertisement or an editor whom is entrusted with advertising by a client. The editing device 110 comprises a data input module 111 for inputting notification editing information.

In an embodiment, the notification editing information includes at least a picture datum and at least a URL link datum. In a preferred embodiment, the notification editing information comprises a picture datum and two URL link data, wherein the picture datum is a static image file or a dynamic image file (such as a GIF file). Even though a user may input the desired picture or the URL link inserted into the notification message by the data input module 111, the text representing the URL link can be set into a text button such as the button with the words “Watch this advertising” or “Official website”, etc. The inputted notification editing information will be sent to the server 120.

The server 120 is communicatively coupled to the editing device 110 and the receiving device 130. The server 120 is provided for receiving the notification editing information. The server 120 includes an insert module 121 for inserting the notification editing information into notification information.

Wherein, the notification information comes from an external notification transmission device 10, and the notification transmission device 10 refers to a device for sending the notification message, and this device may be a server of an APP (such as a weather APP) which will send the pushed weather notice information. In the notification system capable of attaching pictures in accordance with the present invention, the server 120 will insert the notification editing information into the notification information in order to attach pictures and connect to the URL link.

When the notification editing information is inserted into the pushed weather notice information, the weather notice notification information shows the pictures and URL link in the notification editing information, so that the contents of the notification information and the notification editing information are completely not associated with each other. After the notification information is inserted into the notification editing information, such information will be sent to the receiving device 130.

The receiving device 130 may be an electronic networking device such as a personal computer, a tablet PC, or a smartphone used by consumers. The receiving device 130 is communicatively coupled to the server 120. The receiving device 130 comprises a receiving module 131 and a display module 132. The receiving module 131 is provided for receiving the notification information, and the display module 131 is provided for displaying the notification information. In other words, after the receiving device 130 receives the notification information through the receiving module 131, the display module 132 displays the notification information as well as displaying the original text message in the notification information and the inserted notification editing information.

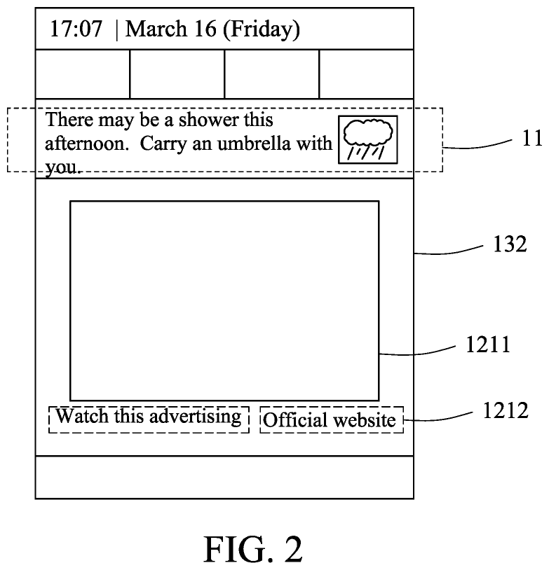

With reference to FIG. 2 for a schematic view of displaying the notification information in accordance with first embodiment of the present invention, the notification information is sent to the receiving device 130, and then the display module 132 displays the notification information. In this embodiment, the notification information includes an original message 11, a picture frame 1211, and a URL link button 1212. The original message 11 is a text message originally included in the notification information such as the pushed weather notice message sent from a weather APP. The picture frame 1211 and the URL link button 1212 display the picture data and the URL link data in the notification editing information respectively.

The picture data will be displayed in the picture frame 1211, and the data of the picture frame 1211 may include an advertising picture or an animation file (such as a GIF file) regarding a car advertising which may be not associated with the original message 11. The URL link data corresponding to the contents of the picture data and the URL link data are expressed in form of a text button. In FIG. 2, the URL link data are words “Official website” and “Watch this advertising” displayed in the URL link button 1212. When a consumer clicks the “Official website”, the website of a product associated with the picture data will be connected. When the consumer clicks “Watch this advertising”, the advertising webpage or streaming media webpage associated with the picture data will be connected. Obviously, the space in the notification information is fully utilized to maximize the exposure of the advertising.

In an embodiment, the URL link data can be combined with the picture data, and such combined data may be installed into the picture frame 1211. In other words, the receiving device 130 can connected to a page corresponding to the URL link data by clicking the picture data in the picture frame 1211. In another embodiment, if the URL link data are linked to a streaming media page, a screenshot or an animation file may be generated by the corresponding streaming media. The screenshot or animation file may be used as picture data which may be integrated with the URL link data into the picture frame 1211. When the consumer clicks the picture frame 1211, the corresponding streaming media will be substituted into the picture frame 1211 for playing.

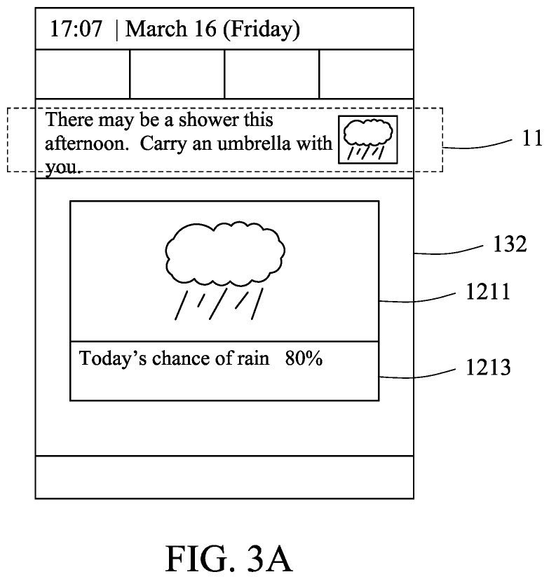

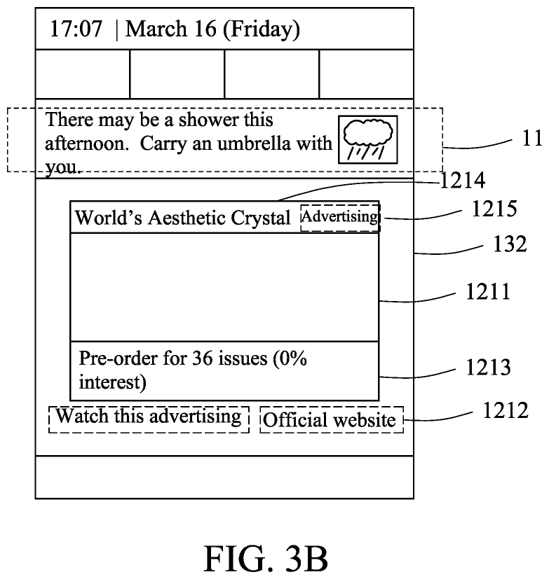

With reference to FIG. 3A for a schematic view of notification advertising in accordance with second embodiment of the present invention, after the receiving device 130 receives the notification information, a picture datum will be attached to the original message 11 of the notification information and then displayed in the picture frame 1211. In addition, the picture frame 1211 further has a text frame 1213 which is covered onto the picture data by a translucent base and contains a text message. In FIG. 3A, the picture frame 1211 and the original message 11 are associated with each other, and they form complete notification information without any advertising.

With reference to FIG. 3B for a schematic view of notification advertising in accordance with third embodiment of the present invention, after the receiving device 130 receives the notification information, the notification information will still show the original message 11. However, an advertising frame 1211 will be installed into the picture data not associated with the original message 11. In addition, the picture frame 1211 further includes a text frame 1213, a title frame 1214, and a label frame 1215. Wherein, the text frame 1213 and the title frame 1214 may record a text message associated with the picture data such as an advertising slogan, etc. The label frame 1215 may label an “advertising” word, indicating that it is an inserted advertising, thus showing a form of “clip” advertising. In this embodiment, the data input module 111 of the editing device 110 may input a text message and a title message into the notification editing information to further control the words displayed in the text frame 1213 and the title frame 1214. In other word, the notification information includes the notification editing information and the original message, the context of the notification editing information is not associated with the context of the original message. Furthermore, the context of the notification editing information is an advertising context. The “clip” advertising can be achieved because the advertising context and the original message are send together.

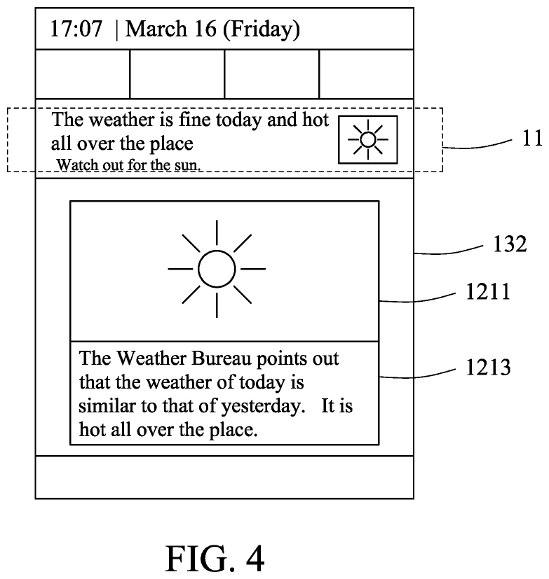

With reference to FIG. 4 for a schematic view of notification advertising in accordance with fourth embodiment of the present invention, the notification information is not installed into the picture data. After the receiving device 130 receives the notification information, the notification information will show the original message 11, and the advertising frame 1211 below will show a picture associated with the original message. In addition, if the number of words of the title of the original message 11 is too large, the title will be displayed in a way by changing size. The text frame 1213 under the advertising frame 1211 will show the textual content of the original message 11 such as a weather news release announced by a weather bureau. The text frame 1213 displays the textual content of the original message 11 provided for a user's preview. If the number of words is too large and the original message 11 cannot be displayed completely, then the symbol “ . . . ” will be used for the displayed.

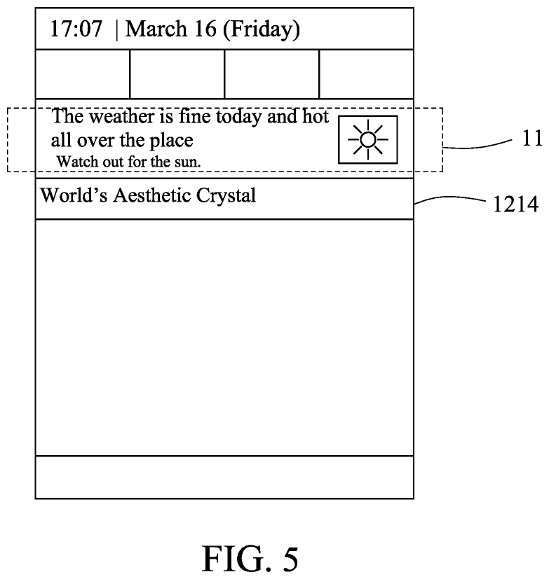

With reference to FIG. 5 for a schematic view of notification advertising in accordance with fifth embodiment of the present invention, the notification information is not installed into the picture data. Besides, the original message 11 are not installed into the picture data. Thus, the advertising frame 1211 below would not be shown, but the title frame 1214 still be shown. The installed title message would be shown in the title frame 1214. Therefore, the textual content of the title frame 1214 is different from the original message 11. The user can click the title message of the title frame 1214 to preview the complete advertising message. The installed advertising message can be shown in more concise way.

When the notification system capable of attaching pictures of the present invention sends the notification information from the APP or webpage, the picture data and the URL link data are inserted into the notification information. The picture data and the URL link data will be shown while displaying the notification information. When an appropriate device is used to display the notification information, the picture data and the URL link data can be displayed in the surrounding space to achieve the effect of maximizing the exposure of the advertising.

In other embodiment, the notification information transmitted to the receiving device 130 from the notification transmission device 10 includes a plurality of information field. In this embodiment, the information field is in compliance with the specification HTML5. Thus, the information fields are predefined. The quantity of information field of the notification information is fixed. Filling in the information outside the information field is not allowed. Besides, only text or image data can be filled in the information field. The receiving device 130 cannot execute any code in the notification information, even if the code is input to the notification information.

The information fields of the notification information include a title field, a text field and an image field. The title field and the text field can be input text data. The image field can be input image data. The data input by the notification transmission device 10 are original message. The original message can be input by the notification transmission device 10 manually and automatically.

In this embodiment, the insert module 121 would detect the information fields of the notification information. If the notification information has empty information fields, the notification editing information would be input into empty information field by the insert module 121. In other word, the insert module 121 would detect empty information fields from the title field, the text field and the image field. Thus, the notification editing information and the original message can be transmitted to the receiving device 130 together.

If the notification information does not have empty information fields, the insert module 121 still inputs the notification editing information into one of the information fields to cover the original message. In other word if the information fields of the notification information are full, the insert module 121 uses the notification editing information to cover the original message. Besides, the insert module 121 only inserts or covers part of the information fields to reserve the original message. Thus, the object of the original message can be reserved to avoid harassment.

In another embodiment, the insert module 121 is further configured to insert a link text into the information field. The method of insert is as same as the notification editing information. The link text would be inserted to empty information fields or cover the original message. The link text is a URL which is connected to the server 120. When the receiving device 130 receives the link text, the receiving device 130 would connect to the server 120. At this time, the server 120 would transmit an advertising data to the receiving device 130. When the receiving device 130 displays the notification information, the advertising data would be displayed with the original message synchronously.

In another embodiment, if the notification information does have empty information field. The link text and original message can be saved in the information field together. When the receiving device 130 receives the link text, the receiving device 130 would connect to the server 120. The server 120 can receive a user data from the receiving device 130. Thus, the server 120 can transmit appropriate advertising data to the receiving device 130 based on the user data. The receiving device 130 uses the advertising data to cover the original message. On the contrary, if the server 120 does not have appropriate advertising data, the original message of the notification information would not be covered and can be displayed.

In the above embodiment, the receiving device 130 connect to the server 120 when the notification information is browsed. For example, user open the notification information store area on the top of the screen. The link text would make the receiving device 130 connect to the server 120. At this time, the receiving device 130 would provide a notification code (i. e. user data) to the server 120. The server 120 would search a cookie ID corresponding to the receiving device 130 based on the notification code. Next, the server 120 transmits appropriate advertising data to the receiving device 130 based on the cookie ID, and the receiving device 130 uses the advertising data to cover original message.

In the above embodiment, the advertising data is inserted into the notification information and displays on the display module 132 when the notification information is browsed. Therefore, the server 120 can transmit timeliness advertising data so the advertising data can be selected optionally. In other word, the advertising data is decided when the notification information is viewed by user.

In addition, the receiving device 130 cannot provide cookie ID proactively because the receiving device 130 cannot execute code inserted in the notification information. However, the receiving device 130 transmitting notification code is an inevitable action. Therefore, the cookie ID of the receiving device 130 is confirmed by the notification code.

Furthermore, there is a subscription between the receiving device 130 and the notification transmission device 10, so the receiving device 130 can receive the notification information from the notification transmission device 10. The receiving device 130 can connect the web corresponding to the notification transmission device 10 to establish subscription with the notification transmission device 10. Besides, the receiving device 130 also can photograph a QR code to get a link and establish subscription with the notification transmission device 10.

While the invention has been described by means of specific embodiments, numerous modifications and variations could be made thereto by those skilled in the art without departing from the scope and spirit of the invention set forth in the claims.

What is claimed is:

1. A notification system capable of attaching pictures, comprising:
an editing device, including a data input module, for inputting notification editing information, and the notification editing information including at least a picture datum and at least a URL link datum; and
a server, communicatively coupled to the editing device, for receiving the notification editing information, and comprising:
an insert module, for receiving the notification editing information, and inserting the notification editing information into a notification information; and
a plurality of receiving devices, communicatively coupled to the server, and the receiving device comprising:
a receiving module, for receiving the notification information; and
a display module, for displaying the notification information.

2. The notification system capable of attaching pictures according to claim 1, wherein the notification editing information includes a picture datum and two URL link data.

3. The notification system capable of attaching pictures according to claim 1, wherein the receiving device is a tablet PC, a smartphone, or a personal computer.

4. The notification system capable of attaching pictures according to claim 1, wherein the notification information comprising the notification editing information and an original message, the context of the notification editing information is not associated with the context of the original message.

5. The notification system capable of attaching pictures according to claim 1, wherein the URL link information in the notification information is expressed in form of a text button.

6. The notification system capable of attaching pictures according to claim 1, wherein the notification information comes from an external notification transmission device, and the notification transmission device is coupled to the server.

7. The notification system capable of attaching pictures according to claim 1, wherein the notification editing information further includes a text message and a title message.

8. The notification system capable of attaching pictures according to claim 1, wherein the notification editing information is an advertising context.

9. The notification system capable of attaching pictures according to claim 1, wherein the notification information further includes a plurality of information field.

10. The notification system capable of attaching pictures according to claim 9, wherein the insert module further is configured to detect the information fields;
if the notification information has empty information fields, the insert module inserts the notification editing information into the empty information fields;
if the notification information does not have empty information fields, the insert module inserts the notification editing information and covers data of the notification information.

11. The notification system capable of attaching pictures according to claim 9, wherein the insert module further is configured to insert a link text into the notification information;
if the notification information has empty information fields, the insert module inserts the link text into the empty information fields;
if the notification information does not have empty information fields, the insert module inserts the link text and cover data of the notification information.

12. The notification system capable of attaching pictures according to claim 11, wherein, when the receiving device receive the link text, the receiving device connect to the server and download an advertising data.
